(19) United States
(12) Patent Application Publication
(10) Pub. No.: US 2013/0297951 A1
(43) Pub. Date: Nov. 7, 2013

(54) OPERATION SYSTEM AND CONTROL METHOD THEREOF

(71) Applicants: Liang Min LEE, New Taipei City (TW); Chia-Hung SU, New Taipei City (TW); Hung-Yi KUO, New Taipei City (TW); Yu Jen CHANG, New Taipei City (TW)

(72) Inventors: Liang Min LEE, New Taipei City (TW); Chia-Hung SU, New Taipei City (TW); Hung-Yi KUO, New Taipei City (TW); Yu Jen CHANG, New Taipei City (TW)

(73) Assignee: VIA TECHNOLOGIES, INC., New Taipei City (TW)

(21) Appl. No.: 13/570,421

(22) Filed: Aug. 9, 2012

(30) Foreign Application Priority Data
May 2, 2012 (TW) 101115540

(51) Int. Cl. G06F 1/28

(52) U.S. Cl. 713/300

(57) ABSTRACT

An operation system including a chipset and a detection unit is disclosed. The chipset includes a first circuit group receiving a plurality of operation voltages. The detection unit generates a control signal to control the first circuit group to stop accessing a memory device when an external power is abnormal. A level of the control signal switches before variation in a level of a first operation voltage among the operation voltages. The variation is induced when the external power is abnormal.

### CROSS REFERENCE TO RELATED APPLICATIONS

This Application claims priority of Taiwan Patent Application No. 101115540, filed on May 2, 2012, the entirety of which is incorporated by reference herein.

### BACKGROUND OF THE INVENTION

1. Field of the Invention

The invention relates to an operation system, and more particularly to an operation system, which de-activates a chipset when an external power is abnormal.

2. Description of the Related Art

With technological development, electronic devices are widely used, such as desktop computers, and mobile products. However, the electronic devices are driven by an external power. The external power is transformed to various operation voltages provided to various elements of the electronic devices. When the external power is abnormal, errors in the operation of the elements may be induced.

### BRIEF SUMMARY OF THE INVENTION

In accordance with an embodiment, an operation system comprises a chipset and a detection unit. The chipset comprises a first circuit group receiving a plurality of operation voltages. The detection unit generates a control signal to control the first circuit group to stop accessing a memory device when an external power is abnormal. A level of the control signal switches before variation in a level of a first operation voltage among the operation voltages. The variation is induced when the external power is abnormal.

In accordance with another embodiment, an operation system comprises a chipset, a detection unit and a supply unit. The chipset comprises a first circuit group and a second circuit group. The first circuit group receives a plurality of operation voltages. The second circuit group does not receive the operation voltages. The detection unit generates a control signal to control the first circuit group to stop accessing a memory device of the second circuit group when an external power is abnormal. The supply unit comprises a power supply and a conversion device. The power supply transforms the external power into a plurality of output powers and generates a reset signal. The conversion device transforms the output powers to generate the output voltages and a success signal. The second circuit group receives a battery voltage provided by a battery unit. The reset signal or the success signal is served as the control signal. A level of the control signal switches before variation in a level of a first operation voltage among the operation voltages. The variation is induced when the external power is abnormal.

An exemplary embodiment of a control method to control a chipset comprising a first circuit group is described in the following. It is determined whether an external power is abnormal. When the external power is abnormal, a control signal is generated to control the first circuit group to stop accessing a memory device. A level change of the control signal occurs before a level change of an operation voltage received by the first circuit group. The level change of the operation voltage is caused when the external power is abnormal.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an operation system;

FIG. 2 is a schematic diagram of an exemplary embodiment of a supply unit;

FIG. 3 is a schematic diagram of an exemplary embodiment of a chipset;

FIG. 4 is a schematic diagram of an exemplary embodiment of the level signal;

FIG. 5 is a schematic diagram of an exemplary embodiment of a control method for a chipset; and

FIG. 6 is a schematic diagram of another exemplary embodiment of the control method for a chipset.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

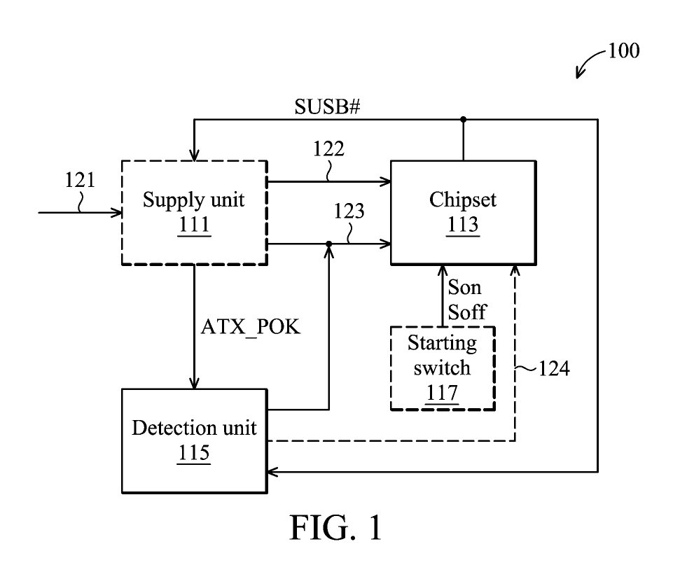

FIG. 1 is a schematic diagram of an exemplary embodiment of an operation system. The invention does not limit the kind of the operation system 100. In one embodiment, the operation system 100 is a personal computer or a mobile electronic device, such as a notebook (NB) or a phone. In this embodiment, the operation system 100 comprises a chipset 113 and a detection unit 115.

The chipset 113 comprises a first circuit group (not shown) to receive various operation voltages. When an external power 121 is abnormal, the detection unit 115 generates a control signal to control the first circuit group to stop accessing a memory device (not shown). A level of the control signal switches before variation in a level of an operation voltage received by the first circuit group. The variation in the level of the operation voltage received by the first circuit group is induced when the external power 121 is abnormal.

In one embodiment, the chipset 113 further comprises a second circuit group (not shown). The second circuit group comprises a memory device. When the external power 121 is abnormal, the detection unit 115 generates a control signal to control the first circuit group to stop accessing the memory device of the second circuit group. In other embodiments, the operation voltage of the memory device is different from each of the operation voltages received by the first circuit group. In one embodiment, the operation voltage of the memory device is a battery voltage.

In this embodiment, the operation system 100 further comprises a supply unit 111. The supply unit 111 transforms the external power 121 to an operation voltage group 122 and generates a control signal group 123. In one embodiment, the external power 121 is an alternating current (AC) voltage, such as 110V or 220V. Additionally, the operation voltage group 122 comprises at least one direct current (DC) voltage provided to the chipset 113. In this embodiment, the operation voltage group 122 comprises various operation voltages.

Any signal can be comprised in the control signal group 123, as long as the signal is capable of controlling the chipset 113. In one embodiment, the control signal group 123 only comprises one control signal. In another embodiment, the control signal group 123 comprises various control signals.

In one embodiment, when the status of the control signal group 123 is at a first status, the first circuit group of the chipset 113 receives the operation voltage group 122 and operates according to the operation voltage group 122. When the status of the control signal group 123 is at a second status, the first circuit group of the chipset 113 stops operating. In this embodiment, the first and the second statuses relate to the levels of the control signals in the control signal group 123. For example, it represents that the status of the control signal group 123 is at the first status when each of the control signals in the control signal group 123 is at a high level. It represents that the status of the control signal group 123 is at the second status when all or a portion of the control signals in the control signal group 123 are at low levels.

In this embodiment, the detection unit 115 detects the supply unit 111 to determine whether the external power 121 is abnormal. For example, when the operation system 100 is unsuitably operated or a power failure, the external power 121 received by the supply unit 111 is abnormal. When the external power 121 is abnormal, the detection unit 115 switches the status of the control signal group 123 to the second status such that the first circuit group of the chipset 113 stops operating.

The invention does not limit how the detection unit 115 obtains the abnormal external power. In this embodiment, the supply unit 111 generates a level signal ATX_POK according to the level of the external power 121. The detection unit 115 obtains that the external power 121 is abnormal according to the level signal ATX_POK. For example, when the external power 121 is normal, the level of the level signal ATX_POK is substantially equal to a pre-determined level. When the external power 121 is abnormal, the level of the level signal ATX_POK is not equal to the pre-determined level. Thus, the detection unit 115 may detect the abnormal external power according to the level of the level signal ATX_POK.

Additionally, in other embodiments, when the external power 121 is abnormal, the detection unit 115 generates an interrupt signal 124 to the chipset 113. A firmware of the chipset 113 executes a data-storing action or a turn-off action to turn off an executed program according to the interrupt signal 124. In this embodiment, the detection unit 115 switches the status of the control signal group 123 to control the hardware of the chipset 113 and generates the interrupt signal 124 to control the firmware of the chipset 113.

In one embodiment, the detection unit 115 resides outside of the chipset 113, but the disclosure is not limited thereto. In other embodiments, the detection unit 115 and the chipset 113 are integrated in an integrated circuit (IC).

In addition, the operation system 100 further comprises a starting switch 117. When the operation system 100 operates in a turning-on mode, the starting switch 117 outputs a turn-on signal Son. When the operation system 100 operates in a shutdown mode, the starting switch 117 outputs a turn-off signal Soff.

The chipset 113 generates a startup signal SUSB# to activate the supply unit 111 or de-activate the detection unit 115 according to the output of the starting switch 117. For example, when the chipset 113 receives the turn-on signal Son, the chipset 113 asserts the startup signal SUSB# to activate the supply unit 111. Thus, the supply unit 111 generates the operation voltage group 122 and the control signal group 123.

Alternatively, when the chipset 113 receives the turn-off signal Soff, the chipset 113 de-asserts the startup signal SUSB# to de-activate the detection unit 115. Thus, the detection unit 115 cannot switch the status of the control signal group 123 to the second status.

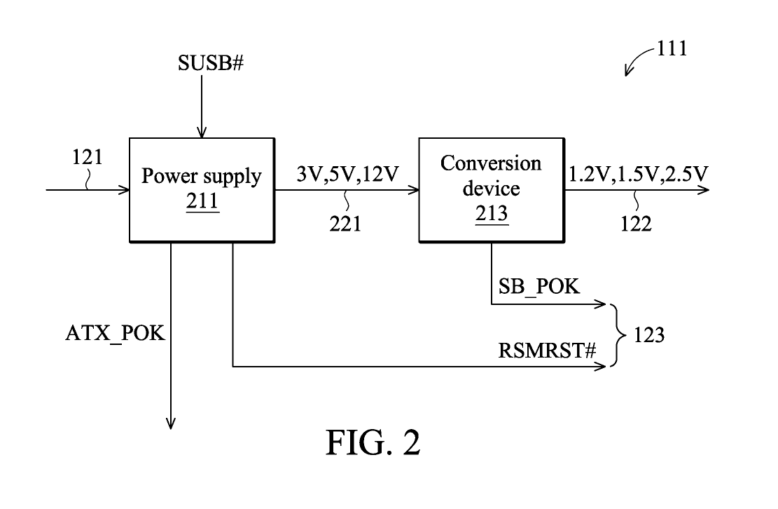

FIG. 2 is a schematic diagram of an exemplary embodiment of a supply unit 111. The supply unit 111 comprises a power supply 211 and a conversion device 213. The power supply 211 transforms the external power 121 to an output power group 221 and generates a reset signal RSMRST# according to the startup signal SUSB#.

The reset signal RSMRST# resets the control circuit of the chipset 113 such that the status of the control circuit in the chipset 113 returns to a pre-determined status. In one embodiment, when the startup signal SUSB# is asserted, the power supply 211 sets the level of the reset signal RSMRST# to a high level. Additionally, in this embodiment, the output power group 221 comprises various DC voltages, such as 3V, 5V and 12V, however, the invention is not limited thereto.

The conversion device 213 transforms the DC voltages of the output power group 221 to generate the operation voltage group 122 and a success signal SB_POK. The success signal SB_POK notifies the chipset 113 that the operation voltage group 122 is ready. For example, when the operation voltage group 122 is generated by the conversion device 213, the level of the success signal SB_POK is at a high level.

In this embodiment, the control signal group 123 comprises the reset signal RSMRST# and the success signal SB_POK, but the disclosure is not limited thereto. Further, the invention does not limit the number and intensity of the operation voltages in the operation voltage group 122. In one embodiment, the operation voltage group 122 comprises operation voltages, such as 1.2V, 1.5V and 2.5V.

Furthermore, the invention does not limit the sequence for which the supply unit 111 outputs the reset signal RSMRST# and the success signal SB_POK. In one embodiment, the supply unit 111 first outputs the reset signal RSMRST# and then outputs the success signal SB_POK, but the disclosure is not limited thereto.

Additionally, the power supply 211 generates the level signal ATX_POK according to the external power 121. For example, when the external power 121 is normal, the level of the level signal ATX_POK is substantially equal to the pre-determined level. However, when the external power 121 is abnormal, the level of the level signal ATX_POK is not equal to the pre-determined level.

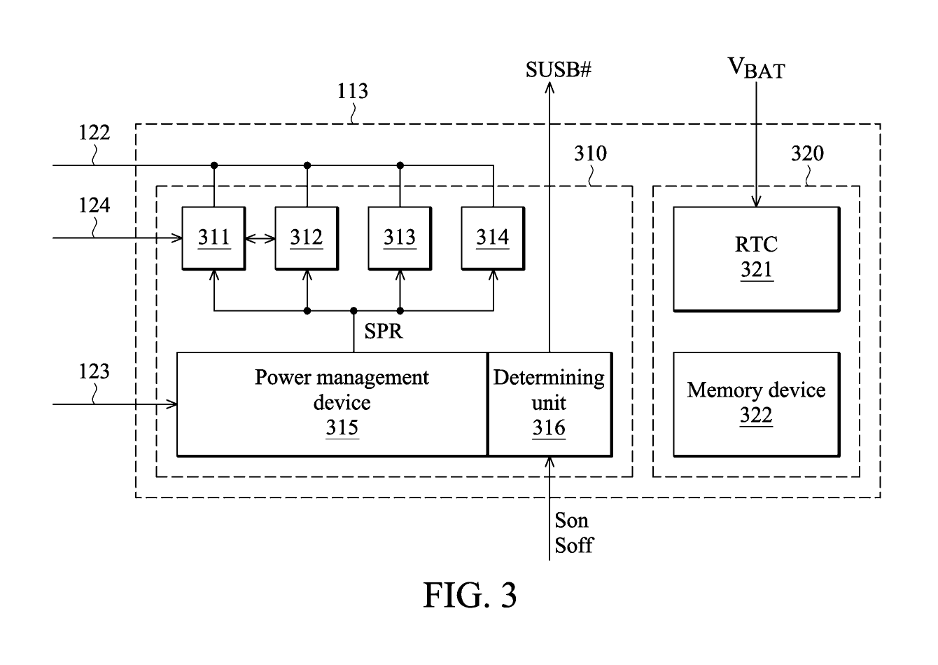

FIG. 3 is a schematic diagram of an exemplary embodiment of a chipset. In one embodiment, the chipset 113 is a south bridge (SB) or an integrated chipset, but the disclosure is not limited thereto. In other embodiments, the chipset 113 may be a chipset in a mobile phone.

Refer to FIG. 3, the chipset 113 comprises a first circuit group 310 and a second circuit group 320. The first circuit group 310 operates according to the operation voltage group 122 generated by the supply unit 111. The second circuit group 320 does not operate according to the operation voltage group 122. As shown in FIG. 3, the second circuit group 320 receives a battery voltage V_{BAT} and operates according to the battery voltage V_{BAT}.

The first circuit group 310 comprises control circuits 311-314 and a power management device 315. Each of the control circuits 311-314 receives a corresponding operation voltage among the operation voltage group 122. For example, the control circuit 311 receives an operation voltage, such as 1.2V. The control circuits 312 and 313 receive another operation voltage, such as 1.5V. The control circuit 314 receives another operation voltage, such as 2.5V. The invention does not limit the number of the control circuits of the first circuit group 310. In this embodiment, the first circuit group 310 comprises, but is not limit to, four control circuits.

The power management device 315 asserts or de-asserts a power ready signal S_{PR} according to the control signal group 123. For example, when the status of the control signal group 123 is at a first status, the power management device 315 asserts the power ready signal S_{PR}. Thus, each of the control circuits 311-314 receives a corresponding operation voltage of the operation voltage group 122 and operates according to the corresponding operation voltage.

However, when the status of the control signal group 123 is at a second status, the power management device 315 de-asserts the power ready signal S_{PR}. Thus, each of the control circuits 311-314 does not operate according to the corresponding operation voltage. In this embodiment, after each of the control circuits 311-314 does not operate, the power management device 315 also stops operating. Thus, the chipset 113 exits a working status.

In this embodiment, the first circuit group 310 further comprises a determining unit 316. The determining unit 316 asserts or de-asserts the startup signal SUSB# according to the output of the starting switch 117. For example, when the determining unit 316 receives the turn-off signal Soff, the determining unit 316 de-asserts the startup signal SUSB# to de-activate the detection unit 115. Thus, the detection unit 115 does not detect the supply unit 111. Contrarily, when the determining unit 316 receives the turn-on signal Son, the determining unit 316 asserts the startup signal SUSB# such that the supply unit 111 transforms the external power 121 to the operation voltage group 122 and generates the control signal group 123.

In one embodiment, the control circuit 312 is a storage unit to store a firmware program. The control circuit 311 is a processing unit to execute the firmware program stored in the control circuit 312. When the external power 121 is abnormal, the detection unit 115 generates an interrupt signal 124 such that the control circuit 311 stops executing the firmware program stored in the control circuit 312.

The second circuit group 320 comprises a real time clock (RTC) 321 and a memory device 322. The RTC 321 and the memory device 322 operate according to a battery voltage V_{BAT}. In this embodiment, the memory device 322 is a complementary metal-oxide-semiconductor (CMOS) static random-access memory (SRAM). In one embodiment, the battery voltage V_{BAT} is provided by a battery unit (not shown).

Since the second circuit group 320 does not operate according to the operation voltage group 122, when the power management device 315 de-asserts the power ready signal S_{PR}, the second circuit group 320 still operates because the second circuit group 320 operates according to the battery voltage V_{BAT}. When the first circuit group 310 is de-activated, it prevents the first circuit group 310 from accessing the memory device 322.

Since the memory device 322 operates according to the battery voltage V_{BAT} and the current provided by the battery voltage V_{BAT} is limited, when the external power 121 is abnormal, the first circuit group 310 may unsuitably access the memory device 322 to capture large currents from the battery unit. Thus, the battery voltage V_{BAT} is unstable.

When the battery voltage V_{BAT} is unstable, the data stored in the memory device 322 may be lost or the operation of the RTC 321 is abnormal. Thus, in this embodiment, when the detection unit 115 determines that the external power 121 is abnormal, the first circuit group 310 is de-activated such that the level of the battery voltage V_{BAT} is maintained at a stable level.

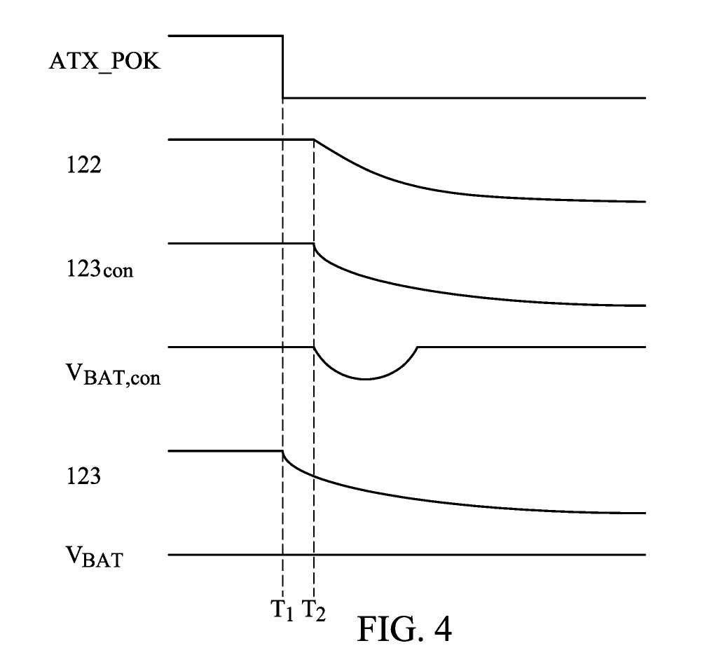

FIG. 4 is a schematic diagram of an exemplary embodiment of the level signal ATX POK. When an external power is abnormal, the level of the level signal ATX POK is switched from a high level to a low level at time T₁. However, the operation voltage group 122 received by a conventional chipset of an electronic device does not immediately respond to the switched level of the level signal ATX_POK. Generally, the operation voltage group 122 comprises at least one operation voltage. When the operation voltage group 122 comprises various operation voltages, the responses of the levels of the operation voltages are similar to each other. Thus, only one operation voltage of the operation voltage group 122 is shown and given as an example. Refer to FIG. 4, the level of the operation voltage of the operation voltage group 122 is switched from a high level to a low level at time T₂.

When the level of the operation voltage of the operation voltage group 122 is switched, a control signal 123 _{con} of a conventional control signal group 123 is switched from a high level to a low level at time T₂. The control signal 123_{con} of the conventional control signal group 123 is utilized to control a chipset. However, the circuits of the chipset are still operating at time T₂ and the level of the operation voltage 122 of the conventional operation voltage group is not sufficient to drive the circuits of the chipset, thus, a memory device is unsuitably accessed by the circuits of the chipset. Thus, the level of the conventional battery voltage V_{BAT,con} provided to the memory device cannot be maintained at a stable level.

Compared with the invention, when the detection unit 115 detects that the level signal ATX_POK is abnormal, the status of one or more signals among the control signal group 123 is switched from a first pre-determined status (e.g. a high level) to a second pre-determined status (e.g. a low level). Thus, the first circuit group 310 of the chipset is de-activated such that the first circuit group 310 cannot access the memory device 322. Thus, the level of the battery voltage V_{BAT} provided to the memory device 322 may be maintained at a stable level.

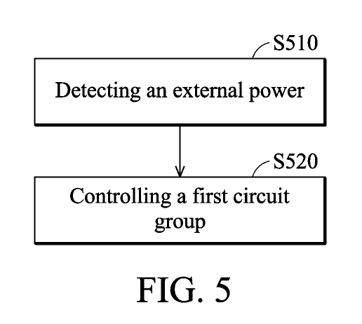

FIG. 5 is a schematic diagram of an exemplary embodiment of a control method for a chipset. The invention does not limit the kind of the chipset. In one embodiment, the chipset is a SB, an integrated chipset or a chipset of a mobile phone.

An external power is detected (step S510) and a first circuit group is controlled according to the detection result generated by step S510 (step S520). In one embodiment, when the external power is abnormal, a control signal is outputted to control the first circuit group to stop accessing a memory device. In this embodiment, a level of the control signal switches before variation of a level of an operation voltage received by the first circuit group. The variation is induced when the external power is abnormal.

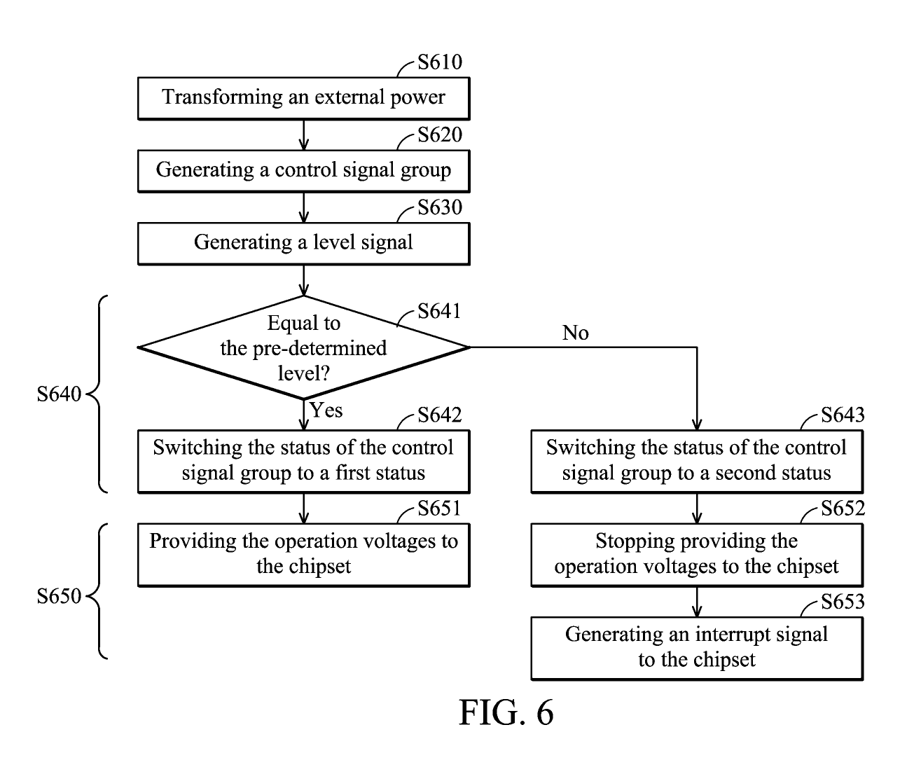

The invention does not limit how the abnormal external power is determined FIG. 6 is a schematic diagram of another exemplary embodiment of the control method. First, an external power is transformed to generate various operation voltages (step S610). The invention does not limit the types of the external power and the operation voltages. In one embodiment, the external power is an AC voltage and the operation voltages are DC voltages.

A control signal group is generated according to the transforming result generated by step S610 (step S620). In this embodiment, the control signal group comprises various signals. For example, the control signal group comprises a reset signal and a success signal. The success signal represents that the external power is successfully transformed by step S610. The reset signal is utilized to reset the control circuits of the chipset such that the status of each control circuit is returned to a pre-determined status.

A level signal is generated according to the external power (step S630). In one embodiment, when the external power is normal, the level of the level signal is substantially equal to a pre-determined level. On the contrary, when the external power is abnormal, the level of the level signal is not equal to the pre-determined level.

The level signal is detected and the control signal group is switched according to the detection result (step S640). In this embodiment, step S640 comprises steps S641˜S643. Step S641 determines whether the level of the level signal is equal to the pre-determined level. When the level of the level signal is substantially equal to the pre-determined level, the status of the control signal group is switched to a first status (step S642). When the level of the level signal is not equal to the pre-determined level, the status of the control signal group is switched to a second status (step S643).

For example, when the level of the level signal is substantially equal to the pre-determined level, each signal of the control signal group is switched to a high level. When the level of the level signal is not equal to the pre-determined level, at least one signal of the control signal group is switched to a low level.

It is determined whether to provide the operation voltages to the chipset according to the status of the control signal group (step S650). In this embodiment, when the status of the control signal group is at the first status, it represents that the external power is normal. Thus, the operation voltages are provided to the chipset (step S651). When the status of the control signal group is at the second status, it represents that the external power is abnormal. Thus, the operation voltages are stopped from being providing to the chipset (step S652). Since the chipset does not receive the operation voltages, a circuit group of the chipset stops operating. In other embodiments, when the status of the control signal group is at the second status, an interrupt signal is generated to the chipset (step S653) to turn off a firmware program of the chipset. In one embodiment, the level of the interrupt signal switches before variation of the level of an operation voltage received by the circuit group. The variation of the level of the operation voltage is induced when the external power is abnormal.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An operation system, comprising:
a chipset comprising a first circuit group receiving a plurality of operation voltages; and
a detection unit generating a control signal to control the first circuit group to stop accessing a memory device when an external power is abnormal,
wherein a level of the control signal switches before variation in a level of a first operation voltage among the operation voltages, and wherein the variation is induced when the external power is abnormal.

2. The operation system as claimed in claim 1, wherein the chipset further comprises a second circuit group, and the second circuit group does not receive the operation voltages.

3. The operation system as claimed in claim 2, further comprising:
a battery unit providing a battery voltage to the second circuit group.

4. The operation system as claimed in claim 3, wherein the second circuit group comprises:
a real time clock (RTC) device operating according to the battery voltage.

5. The operation system as claimed in claim 2, wherein the second circuit group comprises the memory device.

6. The operation system as claimed in claim 1, further comprising:
a supply unit comprising:
a power supply transforming the external power into a plurality of output powers and generating a reset signal; and
a conversion device transforming the output powers to generate the operation voltages and a success signal, wherein the reset signal or the success signal is several as the control signal.

7. The operation system as claimed in claim 1, wherein the first circuit group comprises:
a determining unit de-activating the detection unit according to a turn-off signal in a shutdown mode.

8. The operation system as claimed in claim 1, wherein the first circuit group comprises:
a plurality of control circuits receiving the operation voltages and operating according to the operation voltages when a power ready signal is asserted, wherein the control circuits are idle when the power ready signal is de-asserted,
wherein the power ready signal is asserted when the control signal is at a first status and de-asserted when the control signal is at a second status.

9. The operation system as claimed in claim 8, wherein when the control circuits are idle, a power management device stops operating.

10. The operation system as claimed in claim 1, wherein the first circuit group further comprises:
a processing unit executing a firmware program, wherein when the external power is abnormal, the detection unit outputs an interrupt signal to control the processing unit to stop executing the firmware program,
wherein a level of the interrupt signal switches before the variation in the level of the first operation voltage.

11. The operation system as claimed in claim 1, wherein the chipset is a south bridge (SB) or an integrated chipset.

12. The operation system as claimed in claim 1, wherein the detection unit and the chipset are integrated in an integrated circuit (IC).

13. An operation system, comprising:
a chipset comprising a first circuit group and a second circuit group, wherein the first circuit group receives a plurality of operation voltages, and the second circuit group does not receive the operation voltages;
a detection unit generating a control signal to control the first circuit group to stop accessing a memory device of the second circuit group when an external power is abnormal,
wherein the second circuit group receives a battery voltage provided by a battery unit, and a reset signal generated by a power supply or a success signal generated by a conversion device is served as the control signal, and
wherein a level of the control signal switches before variation in a level of a first operation voltage among the operation voltages, wherein the variation is induced when the external power is abnormal.

14. A control method to control a chipset comprising a first circuit group, comprising:
generating a control signal to control the first circuit group to stop accessing a memory device when an external power is abnormal,
wherein a level change of the control signal occurs before a level change of a operation voltage received by the first circuit group, and the level change of the operation voltage is caused when the external power is abnormal.

15. The control method as claimed in claim 14, further comprising:
detecting a level signal generated according to the external power to generate a detection result; and
changing the level of the control signal according to the detection result.

16. The control method as claimed in claim 14, wherein the memory device

17. The control method as claimed in claim 14, wherein an operation voltage of the memory device is provided by a battery unit.

18. The control method as claimed in claim 14, further comprising:
outputting an interrupt signal to control a processing unit to stop executing a firmware program when the external power is abnormal, wherein a level of the interrupt signal switches before variation in the level of the
